(19) United States
(12) Patent Application Publication
(10) Pub. No.: US 2016/0069121 A1
(43) Pub. Date: Mar. 10, 2016

(54) One-piece framing device for a window-type opening, method for the installation thereof and production method thereof

(71) Applicant: Julien Durand, Bretagnolles (FR)

(72) Inventor: Julien Durand, Bretagnolles (FR)

(21) Appl. No.: 14/782,633

(22) PCT Filed: Mar. 21, 2014
(86) PCT No.: PCT/EP2014/055734

§ 371 Date: Oct. 6, 2015

(30) Foreign Application Priority Data
Apr. 8, 2013 (FR) 1353131

(51) Int. Cl. E06B 1/26; E06B 1/56; E06B 1/24

(52) U.S. Cl. CPC E06B 1/26; E06B 1/24; E06B 1/56

(57) ABSTRACT

The framing device includes an upper lintel (20) and a lower support (22).

The lintel (20) with an L-section including a first branch (34) able to cover the upper wall (14), and a second branch (36) able to cover the outer (10) or inner (11) surface of the wall (2).

The support (22) has an L-section such that the support (22) comprises a first branch (38) able to cover the lower wall (16), and a second branch (40) able to cover the outer (10) or inner (11) surface of the wall (2).

The support (22) and the lintel (20) are molded together.

The present invention relates to a prefabricated framing device for an opening, for example for a door or a window, made in a wall having an outer surface, an inner surface and a thickness, the opening being delimited in the thickness of the wall by an inner wall, the inner wall comprising an upper wall, a lower wall and at least one side wall, the upper wall facing the lower wall, the device being of the type including an upper lintel and a lower support, the lintel with an L-section including a first branch able to cover the upper wall, and a second branch able to cover the outer or inner surface of the wall.

The framing device may for example be positioned in a rectangular opening made in a brick wall, with view to subsequently placing a window block therein, i.e., an assembly comprising a casing, glass panels, shutters, . . .

### BACKGROUND

In a known way, the framing devices are either in independent elements, then generally consisting of a window support, two jambs and a lintel which are either assembled or not before laying it in the opening, or one-piece framing devices, but then they integrate woodwork, i.e. the aforementioned window block.

In document FR 2 865 760, a framing device in independent elements is disclosed. It comprises two portions: a first portion including the lintel and the two jambs and a second portion including the window support. Both portions are assembled with attachment means before being placed in the opening. A chemical gasket was placed beforehand on the walls of the opening.

Such a device, relatively simple to install, therefore gives the possibility of ensuring a good seal of the opening, and has the advantage of reducing the thermal bridge generated around the window. However, the installation of this device may prove to be quite long.

### SUMMARY OF THE INVENTION

It is an object of the present invention to provide a simply and rapidly installed framing device, having good thermal insulation and seal properties.

The present invention provides a framing device of the aforementioned type, wherein the support has an L-section such that the support comprises a first branch able to cover the lower wall, and a second branch able to cover the outer or inner surface of the wall, and the support and the lintel are molded together in the same material.

According to other advantageous aspects of the invention, the framing device includes one or several of the following features, taken individually or according to all the technically possible combinations:

the device comprises at least one jamb with an L-section molded together with the support and the lintel, said or each jamb including a first branch able to cover said or each corresponding side wall, and a second branch able to cover the outer or inner surface of the wall;

the support and the lintel are in polymeric concrete;

the support and the lintel are in a same material;

the device comprises two jambs forming with the support and the lintel a one piece frame in a polymeric concrete;

the support and the lintel are in a material loaded with metal fibers;

the thicknesses of the lintel and of the support are comprised between 0.5 and 5 cm; and

the device comprises a frame forming the lintel and the support, and a thermal insulator interposed between the inner wall and the frame.

The object of the invention is also a method for installing the prefabricated framing device in an opening, for example for a door or a window, made in a wall having an outer surface, an inner surface and a thickness, the opening being delimited in the thickness of the wall by an inner wall, the inner wall comprising an upper wall, a lower wall and at least one side wall, the upper wall facing the lower wall, characterized in that the method comprises at least the following steps:

providing a framing device as described earlier,

laying the framing device in the opening, and

attaching the framing device to the wall.

The method may also have one or several of the features below taken individually or according to all the technically possible combinations:

the framing device comprises a frame forming the lintel and the support, and a thermal insulator, the step for laying the framing device comprises a step for:

covering the inner wall of the opening with the thermal insulator, preferably with a stiff insulating foam,

introducing the frame into the opening, the introduction being made in a direction normal to the outer or inner surface of the wall, and

mechanically abutting against the outer or inner surface of the wall second branches of the lintel and of the support;

the framing device is attached to the wall at least with an adhesive;

the framing device comprises a frame forming the lintel and the support, the frame being first brought from an inner side of the wall in a laid position, and then moved through the opening of the wall as far as an outer side of the wall, placed in a vertical position, and then laid in the opening by mechanically abutting against the outer surface of the wall second branches of the lintel and of the support;

the method comprises a step for cutting out at least the first branches of the lintel and of the support in order to adapt it to the depth available in the opening.

The invention also deals with a method for manufacturing a framing device of the aforementioned type, comprising the following steps:

making a matrix of the opening equipped with the framing device;

casting a flexible mold on the matrix;

molding the framing device by means of the mold;

drying in air; and

removing it from the mold.

### BRIEF DESCRIPTION OF THE DRAWINGS

The invention will be better understood upon reading the description which follows, only given as an example, made with reference to the appended drawings wherein:

FIG. 1 is a front view of a framing device according to the invention positioned in an opening made in a wall,

FIG. 2 is an exit section along the plane II of FIG. 1,

FIG. 3 is an exit section along the plane III of FIG. 1,

FIG. 4 schematically illustrates an embodiment of the installation method of the invention, and

FIGS. 5 to 9 illustrate various successive steps of the manufacturing method according to the invention.

### DETAILED DESCRIPTION

In the description, the terms of [symbol] vertical [symbol] and [symbol] horizontal [symbol] are defined according to the usual directions of an erected built up wall, i.e., the term of [symbol] vertical [symbol] refers to the height of the wall and the term of [symbol] horizontal [symbol] refers to a vertical normal plane.

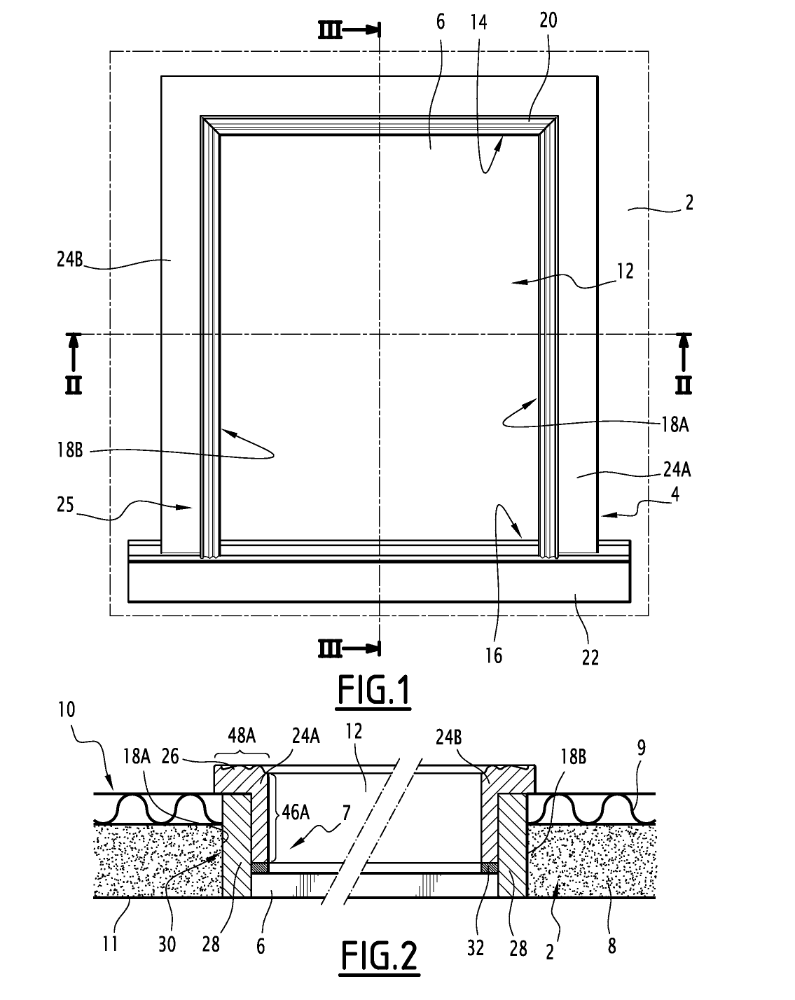

In FIGS. 1 to 3, a frontage portion of a building is illustrated. This frontage comprises a wall 2, a framing device 4, a window block 6 and means 7 for installing this window block 6.

As visible in FIG. 2, the wall 2 comprises a load bearing wall 8 and an insulator layer 9. The load bearing wall 8 is for example in bricks. The insulating layer 9 is typically mineral wool trapped in a framing system and a cladding. Here, the insulating layer 9 is external since it delimits an outer surface 10 of the wall 2. The load bearing wall 8 defines an inner surface 11 of the wall, which for example is covered with one or several layers not shown, typically having a decorative function or a thermal insulation function.

In the wall 2, an opening 12 is further made. The opening 12 is delimited by a horizontal upper wall 14, a horizontal lower wall 16 and two vertical side walls 18A and 18B (FIG. 1).

The framing device 4 comprises a lintel 20, a window support 22 and two jambs 24A and 24B. The lintel 20 and the support 22 substantially extend horizontally and respectively cover the upper wall 14 and the lower wall 16 of the opening 12. Both jambs 24A and 24B are identical. They extend substantially vertically and respectively cover the side walls 18A and 18B of the opening 12.

The lintel 20, the support 22 and both jambs 24A and 24B form a frame 25. The frame 25 is a one-piece structure molded in one single piece. For example it consists of concrete. Preferentially, the material used is polymeric concrete, i.e., a concrete comprising cement, a resin and aggregates for which the grain size does not exceed 16 mm. The resin for example is one from among polyester resin, vinylester resin and acrylic resin. The aggregates for example are sands from one among quartz, basalt, granite, feldspar, mica and spar. The polymeric concrete may be reinforced with metal fibers with the length comprised between 0.1 and 10 cm, preferably between 1 and 3 cm, with a width comprised between 0.1 mm and 1 mm. For example, the width of the fibres is 0.5 mm. The fibers preferably are in stainless steel.

Alternatively, the fibers are in polyethylene or nylon.

The framing device 4 also comprises moldings 26 covering the frame 25 so as to improve the esthetical aspect of the framing device 4. Their shape is totally arbitrary: here, they have a section having rounded shapes. They are molded together with the frame.

The window block 6 is a known element; it will not be further described.

The installation means 7 comprise a thermal insulator 28, attachment means 30 and sealing means 32. The thermal insulator 28 is preferably a stiff insulating foam, notably of polyurethane. The polyurethane 28 is distributed over the upper 14, lower 16 and side 18A, 18B walls, under the frame 25. The sealing means 32 for example are a plastic or silicone gasket.

On the exit section along the plane II in FIG. 2 are notably illustrated the section of the lintel 20 and the section of the window support 22.

The lintel 20 adopts an L-profile, for which one first horizontal branch 34 covers the polyurethane layer 28 distributed over the upper wall 14 and a second vertical branch 36, shorter than the first branch 34, juts out over the outer surface 10 of the wall 2, so as to partly cover it.

The window support 22 substantially adopts an L-profile having a first branch 38 and a second branch 40. The first branch 38 has an oblique direction with respect to the horizontal, so that the angle formed by the first branch 38 and the second branch 40 is comprised between 90 and 180°. The first branch 38 covers the polyurethane layer 28 distributed over the lower wall 14. The second vertical branch 40, shorter than the first branch 38, juts out over the outer surface 10 of the wall 2, so as to partly cover it. Further, the first branch 38 has at its free end, a vertical raised portion 42 against which the window block 6 is in contact. The second branch 40 of the support includes at its horizontal free end a drip 44. The drip 44 is a hollow spline on the underside of the second branch 40.

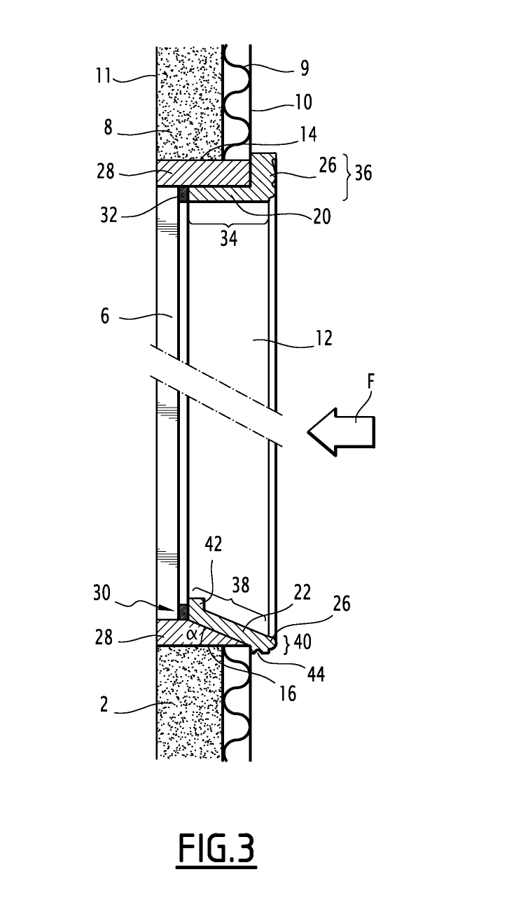

As the jambs 24A and 24B are identical, only the description of the jamb 24A will be detailed here. The jamb 24A, a section of which is illustrated in FIG. 3, also adopts an L-profile for which a first branch 46A covers the polyurethane layer 28 distributed over the side wall 18A and a second branch 48A, shorter than the first branch 46A, juts out over the outer surface 10 of the wall 2, so as to cover it partly. The free end of the first branch 46A of the jamb 24A is in contact with the window block 6.

The lintel 20, the support 22 and the jambs 24A, 24B each have a thickness of polymeric concrete comprised between 0.5 and 5 cm, preferably comprised between 0.5 and 3 cm, and further preferably comprised between 1 and 2 cm.

The method for installing the framing device 4 into the opening 12 of the wall 2 will now be described, with reference to FIGS. 1 to 3.

The installation of the framing device 4 may be carried out during the building of the wall 2 or after its building.

First of all, a polyurethane layer 28 is sprayed on the walls 14, 16, 18 of the opening 12.

Next, the framing device 4 is put facing the opening 12, so that the lintel 20 is horizontal and vertically above the support 22.

The framing device 4 is subsequently inserted in a direction transverse to the wall 2, i.e., in a direction normal to the outer surface, in the direction of the arrow 50 illustrated in FIG. 2. The frame 25 is inserted into the opening until mechanical abutment of the second branches 36, 40, 48 against the outer surface 10 of the wall 2.

The device 4 is then attached in the opening 12 by means of attachment means 30. These attachment means 30 are known per se, and may be an adhesive bond and/or a screwed bond for example.

As the framing device 4 is thereby installed, the laying of the window block 6 may now be achieved. The window block 6 is attached to the wall 2, so that the framing device does not mechanically support the window block 6.

Further, silicone gaskets 32 are used for ensuring the seal of the installation.

The method may include a step for cutting out the first branches of the jambs and of the lintel, in order to adapt them to the available depth in the opening. Indeed, depending on the number and on the nature of the layers which cover the wall on the inside, the total thickness of the wall may vary. The window block is not always placed at the same depth with respect to the outer surface 10 of the wall. The first branches are again cut, when necessary, in order to just reach the proximity of the window block.

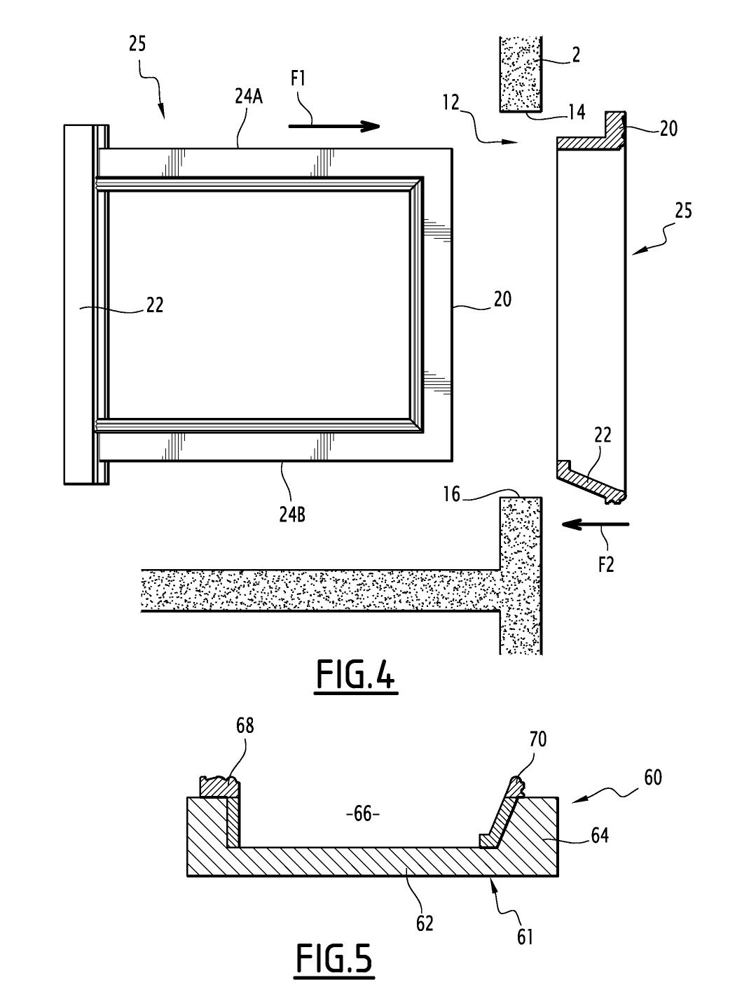

In an embodiment illustrated in FIG. 4, the frame 25 is brought from an inside of the wall so as to be then attached on the outer side of the wall. The frame 25 is schematically illustrated in FIG. 4. It is seen that the lintel 20 and the support 22 have respective lengths smaller than those of the jambs 24A and 24B. In order to allow the framing device 4 to pass through the opening 12, the frame 25 is placed in a laid position, i.e., with the lintel 20 and the support 22 positioned along a substantially vertical orientation and the jambs 24A and 24B follow a substantially horizontal orientation. In this position, it is possible to have the framing device 4 pass through the opening 12.

After having the frame 25 pass from the outer side of the wall, according to a movement illustrated by the arrow F1 of FIG. 4, the frame 25 is placed in a substantially vertical orientation, i.e., with the jambs 24A and 24B vertical and the lintel 20 and the support 22 substantially horizontal. It is then possible to insert the frame 25 into the opening until the second branches of the lintel 20, of the support 22 and of the jambs 24A and 24B bear upon the outer surface 10 of the wall. This movement is materialized by the arrow F2 of FIG. 4.

The pivoting movement of the frame 25 allowing it to pass from the laid position to the vertical position is controlled by any suitable means.

Such an installation method is particularly advantageous for buildings with great heights.

Alternatively, the frame 25 is brought from the outside of the wall and not from the inside. It does not pass through the opening. It is directly laid on the outer side of the wall.

The method for manufacturing the device 4 will now be described, with reference to FIGS. 5 to 9.

As visible in FIG. 5, the method includes an initial step for making a matrix 60 of the opening equipped with the framing device. The matrix 60 includes a support 61, having a flat bottom 62 and an erected edge 64. The erected edge 64 is with a closed contour and interiorly delimits a volume 66 having the size and the shape of the opening 12. This space 66 is closed on one side by the bottom 62 and is open opposite to the bottom 62. The matrix 60 further includes elements 68, 70 having the shape of the lintel, of the support 22 and of the jambs 24A and 24B. These elements are laid on the erected edge 64, exactly in the arrangement provided in the opening 12. In the illustration of FIG. 4, the element 68 corresponds to the lintel 20 and the element 70 to the support 22.

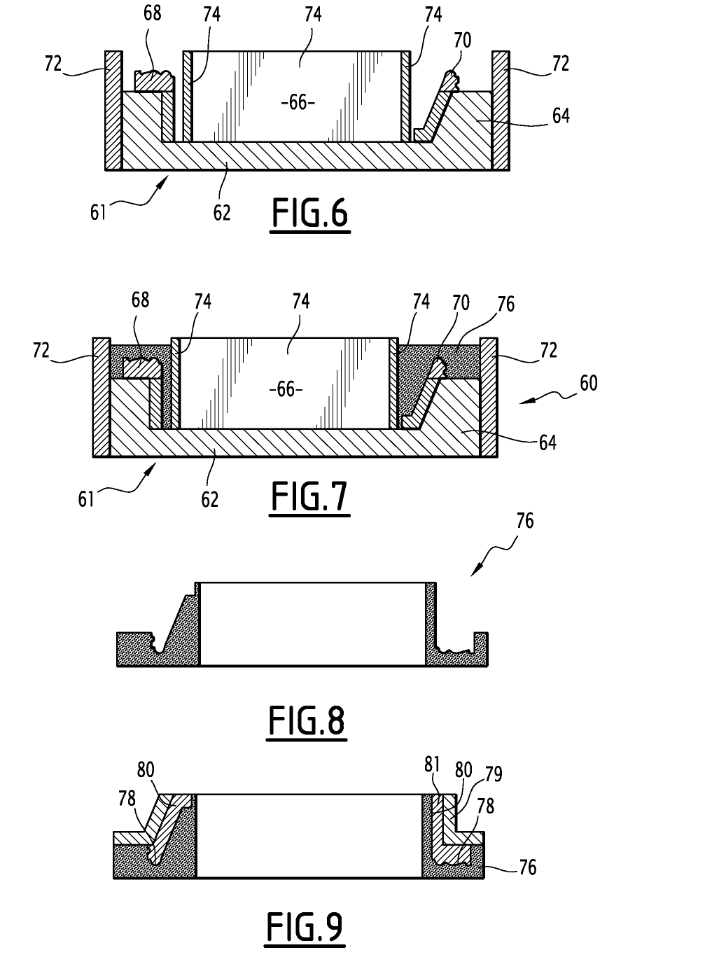

Next, as illustrated in FIG. 6, sealing plates 72, 74 are placed around the matrix, and inside the latter. The plates 74 are positioned in the space 66, parallel to the edge 64, and are slightly moved away from the elements 68 and 70. The sealing plates 72 are placed outside the space 66, over the whole perimeter of the erected edge 64. They are flattened against the erected edge 64.

The plates 72 and 74 slightly protrude above the elements 68 and 70.

As illustrated in FIG. 7, a flexible mold 76 is then cast on the matrix 60. More specifically, liquid silicone is poured between the sealing plates 72 and 74. The silicone will be housed between the plates 74 and the elements 68, 70. It will also cover the portion of the elements 68 and 70 which are flattened on the edge of the rim 64.

After cooling and solidification of the silicone, the plates 72 and 74 are removed, and the flexible mold 76 is separated from the support 61. The mold 76 has the shape illustrated in FIG. 8. This mold 76 is then used for molding the frame 25.

A counter-mold 79 is set into place around the mold 76, as visible in FIG. 9. The counter mold 79 and the mold 76 define between them a space 81 having the shape of the frame 25. The counter mold 79 defines the non-visible side of the frame 25. For example it is in silicone. For example it has an L-section.

The polymeric concrete 80 is poured into the space 81, and notably fills the imprint 78 left in the mold by the shapes 68, 70 (FIG. 9). The polymeric concrete 80 was prepared separately, and notably the metal fibers were mixed with this polymeric concrete.

Finally, after drying in air, the frame 25 is removed from the mold. The flexible mold detached from the frame 25 is able to be reused.

Such a molding method, combined with the use of a particularly resistant polymeric concrete, gives the possibility of making one-piece frames of the desired shape, which are particularly lightweight.

Thus, the framing device 4 according to the invention because of its one-piece nature, has very rapid installation after molding. Further, the L-section of its frame 25 gives the possibility of ensuring a good seal of the opening 12 and gives the possibility of perfectly covering a layer of insulating materials 28, thereby ensuring the insulation of the opening and reducing the thermal bridges.

Further, the framing device 4, because it has very thin thicknesses, which may be made by the use of polymeric concrete, is transportable by hand since the mass of the device has been reduced.

Finally, moldings may easily be made and give the possibility of guaranteeing the aesthetics of the part and of obtaining window framings, the aspect of which may be customized.

The framing device may be placed either against the inner surface of the wall or against the outer surface. The wall may also form an internal partition of a building.

In FIG. 3, the insulating layer 9 has been illustrated defining the external surface of the wall, and the frame 25 is flattened against this insulating layer 9. Alternatively, the insulating layer 9 is internal and defines an internal surface of the load-bearing wall 8. The frame 25 is then flattened against the external surface of the load-bearing wall 8.

1-13. (canceled)

14. A prefabricated framing device for an opening, made in a wall having an outer surface, an inner surface and a thickness, the opening being delimited in the thickness of the wall by an inner wall, the inner wall comprising an upper wall, a lower wall and at least one side wall, the upper wall facing the lower wall, the device comprising:
an upper lintel; and
a lower support,
the lintel with a lintel L-section including a first lintel branch able to cover the upper wall, and a second lintel branch able to cover the outer or inner surface of the wall,
the support having an L-section such that the support comprises a first branch able to cover the lower wall, and a second branch able to cover the outer or inner surface of the wall, and
the support and the lintel being molded together.

15. The device as recited in claim 14 further comprising at least one jamb with an L-section molded together with the support and the lintel, the jamb including a first jamb branch able to cover the corresponding side wall, and a second jamb branch able to cover the outer or inner surface of the wall.

16. The device as recited in claim 14 wherein the support and the lintel are in a polymeric concrete.

17. The device as recited in claim 14 wherein the support and the lintel are in a material loaded with metal fibers.

18. The device as recited in claim 14 wherein the thicknesses of the lintel and of the support are comprised between 0.5 and 5 cm.

19. The device as recited in claim 14 wherein the lintel and the support define a frame, and further comprising a thermal insulator interposed between the inner wall and the frame.

20. The device as recited in claim 14 wherein the opening is a door or a window.

21. A method for installing a prefabricated framing in an opening made in a wall having an outer surface, an inner surface and a thickness, the opening being delimited in the thickness of the wall by an inner wall, the inner wall comprising an upper wall, a lower wall and at least one side wall, the upper wall facing the lower wall, the method comprising:
providing the framing device as recited in claim 14;
laying the framing device in the opening, and
attaching the framing device to the wall.

22. The installation method as recited in claim 21 wherein the lintel and the support define a frame, and the framing device further comprises a thermal insulator, the laying step comprising:
covering the inner wall of the opening with the thermal insulator;
introducing the frame into the opening, the introduction being made in a direction normal to the outer or inner surface of the wall, and
having the second lintel branch of the lintel and the second branch of the support mechanically abut against the outer or inner surface of the wall.

23. The installation method as recited in claim 22 wherein the thermal insulator is a rigid insulating foam.

24. The installation method as recited in claim 22 wherein the framing device is attached to the wall with at least one adhesive.

25. The installation method as recited in claim 21 wherein the lintel and the support define a frame, the frame being first brought from an interior side of the wall in a laid position, and then moved through the opening of the wall as far as an outer side of the wall, placed in a vertical position, and then laid in the opening by having the second branches of the lintel and of the support mechanically abut against the outer surface of the wall.

26. The installation method as recited in claim 21 further comprising a step for cutting out at least the first lintel branch of the lintel and the first branch of the support for adapting the support to the available depth in the opening.

27. The installation method as recited in claim 21 wherein the opening is a door or a window.

28. A method for manufacturing the framing device as recited in claim 14 comprising:
making a matrix of the opening equipped with the framing device;
casting from a flexible mold onto the matrix;
molding of the framing device via the mold;
drying in air; and
removal from the mold.
